(19) United States
(12) Patent Application Publication
(10) Pub. No.: US 2009/0067415 A1
(43) Pub. Date: Mar. 12, 2009

(54) Optical network terminal with integrated internet protocol private branch exchange

(76) Inventors: David H. Liu, Herndon, VA (US); Guy M. Merritt, Purcellville, VA (US); Wen-Bing Shiu, Potomac Falls, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/899,737

(22) Filed: Sep. 7, 2007

(51) Int. Cl. H04L 12/66

(52) U.S. Cl. 370/354

(57) ABSTRACT

Internet Protocol (IP) private branch exchange (IP-PBX) functionality may be provided on existing optical network terminal (ONT) hardware without support of an IP-PBX device by using a method of managing an IP-PBX that includes identifying IP configuration data on downstream network communications associated with at least one private IP branch exchange service received from an upstream node on a session initiation protocol (SIP) network and applying the configuration data to a node in an access network that supports the IP-PBX service. In this way, centralized configuration of IP-PBX services are supported, simplifying network management for service providers.

### BACKGROUND OF THE INVENTION

Passive optical networks (PON) are currently used in telecommunications to provide network services to end users. Example services include telephone, cable television, and the Internet. Passive optical networks, as used in current practice, typically include a service provider network, optical line terminal, multiplexer/demultipelxer, optical network units or terminals, and end user equipment connected via interconnections by optical fiber.

An optical network terminal (ONT) provides an interface between a telecommunications company's fiber optic line providing communications service to a building and one or more wiring networks within the building. An ONT typically uses ONT operating parameters to operate in a PON. Examples of ONT operating parameters include parameters for ATM Adaptation Layer Type 1 (AAL1)/Session Initiation Protocol (SIP) mode, Ground Start/Loop Start mode, and video administrator state.

A private branch exchange (PBX) is a telephone exchange that serves a private business or office, as opposed to an exchange that a common carrier or telephone company operates for many businesses or for the general public. PBX systems provide many communication features such as voicemail, conference call, speed dial, call waiting, and/or call transfer. PBX system architectures have evolved from providing direct digital connections with a PBX set to an IP based PBX for home or small office environment. To support an IP-PBX, an external IP-PBX device connects to the broadband service provided by an ONT. PBX capabilities have become desired features for many small business users and residential subscribers.

### SUMMARY OF THE INVENTION

Instead of connecting an external Internet Protocol private branch exchange (IP-PBX) device to an optical network terminal (ONT), a method of managing an IP-PBX according to an example embodiment may include identifying IP-PBX configuration data on downstream network communications associated with at least one private IP branch exchange service received from an upstream node on a session initiation protocol (SIP) network. The configuration data may be applied to a node in an access network that supports the IP-PBX service. The example embodiment provides PBX functionality using existing ONT hardware.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the invention.

FIG. 1 is a high level network diagram of a communications network providing Internet Protocol (IP) private branch exchange (IP-PBX) services to a local network using an external IP-PBX device;

FIG. 2 is a high level network diagram of a communications network providing IP-PBX services to a local network according to an example embodiment of the invention;

FIG. 3 is a block diagram of an optical networking terminal having an integrated IP-PBX of FIG. 2;

FIG. 4A is a block diagram of a PBX personality according to an example embodiment of the invention;

FIG. 4B is a flow diagram illustrating a procedure according to an example embodiment of the invention;

FIG. 4C is a flow diagram illustrating a procedure according to another example embodiment of the invention; and

FIG. 5 is detailed block diagram of an optical network terminal in PBX personality operation.

### DETAILED DESCRIPTION OF THE INVENTION

A description of example embodiments of the invention follows.

An example embodiment of the invention provides, and allows management of, PBX functionality using existing optical network terminal (ONT) hardware, without requiring a connection to an external Internet Protocol (IP) private branch exchange (IP-PBX) device to the ONT. The example embodiment may include identifying IP configuration data on downstream network communications associated with at least one private IP branch exchange service received from an upstream node on a session initiation protocol (SIP) network, and applying the configuration data to a node in an access network that supports the IP-PBX service. The example embodiment provides a centralized configuration for private branch exchange services.

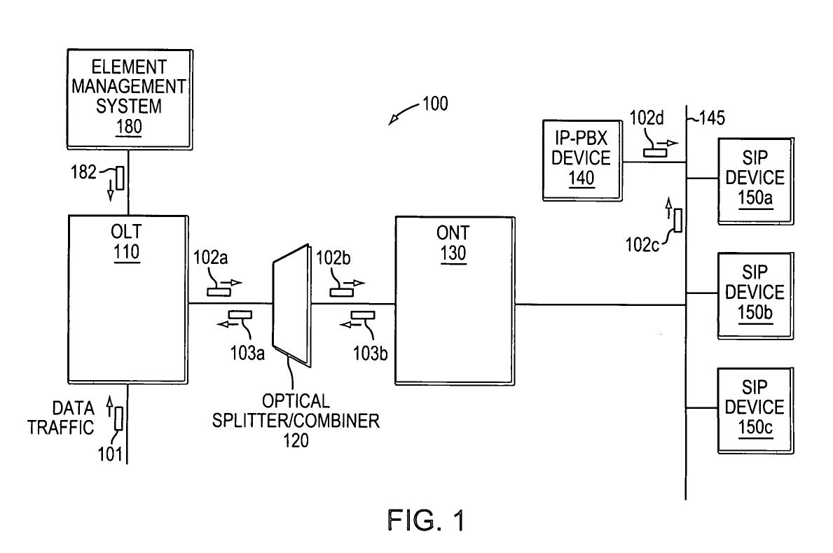

FIG. 1 is a network diagram of a typical communications system 100 providing IP-PBX services to a local area network using an IP-PBX device. The system 100 includes an optical line terminal (OLT) 110, an optical splitter/combiner (OSC) 120 and, at least one optical network terminal (ONT) 130. Data (e.g content) 101 may be received at the OLT 110 from upstream communications traveling through the public switch telephone network (PSTN) to voice over internet protocol (VoIP) terminal, or through internet connections (not shown in FIG. 1). An element management system 180 may provide pre-provisioning data 182 to the OLT 110, which is then forwarded to the ONT 130. The pre-provisioning data facilitates communication of downstream data (e.g., content) 102a, 102b, 103a, 103b between the OLT 110 and an ONT 130. Communications may be performed using standard communications protocols known in the art. For example, downstream data 102a, 102b may be broadcast with identification (ID) data to identify intended recipients for transmitting the downstream data 102a, 102b from the OLT 110 through optical splitter/combiner 120 to the ONT 130. Time division multiple access (TDMA) may be used for transmitting the upstream data 103, 103b from individual ONT 130 through optical splitter/combiner 120 back to the OLT 110. Data communications may include traffic on a Physical Layer Operations, Administration, and Maintenance (PLOAM) channel, an Operations Management and Control Interface (OMCI) channel, or an in-band traffic channel.

The ONT 130 communicates with an IP-PBX Device 140 and local user agents 150a-c over a shared BUS 145, such as an Ethernet connection. In the system 100 illustrated in FIG. 1, data communications 102c may be transmitted from an ONT 130 in the form of voice communications or provisioning data to the IP-PBX device 140. The IP-PBX device 140 maintains a directory of all user agents 150a-c and their corresponding SIP addresses by registering and assigning extension addresses to the user agents 150a-c. The IP-PBX device is capable of directing the data communications 102d to its intended user agent 150a-c. Thus, the IP-PBX device 140 is able to connect an internal call (i.e., between user agents 150a-c), or route an external call via the ONT 130.

In addition to mapping and managing the local extensions of the local user agents 150a-c, the IP-PBX device may provide the local user agents 150a-c with IP-PBX services, such as voicemail, conference call, speed dial, call waiting, and/or call transfer.

In other network embodiments, optical network units (ONUs) (not shown) may be in optical communication with multiple ONT(s) 108 or directly in electrical communication with end user equipment, such as routers, telephones, home security systems, and so forth (not shown). Further, one skilled in the art will recognize that the above system 100 may form part of a larger passive optical network (PON) that may include other network elements, such as a service provider, a network management system, one or more content servers, a wide area network (WAN), one or more element management systems (EMS), connections with the internet or the public switch telephone network (PSTN), and so forth (not shown).

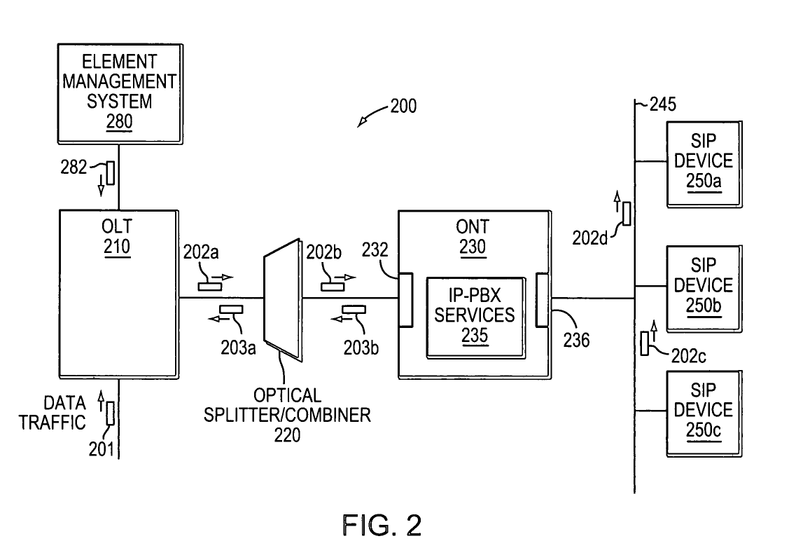

FIG. 2 is a high level network diagram of a communications system 200 providing IP-PBX services to a local area network according to an example embodiment of the invention. Similar to the system 100 described above with respect to FIG. 1, the system 200 of FIG. 2 includes an optical line terminal (OLT) 210, an optical splitter/combiner (OSC) 220, and at least one optical network terminal (ONT) 230. Upstream communications from the ONT 230 of FIG. 2 may be similar to the upstream communications from the ONT 130 of FIG. 1, as data (e.g content) 201 may be received at the OLT 210 from upstream communications.

Again, an element management system 280 may provide or pre-provisioning data 281 to the OLT 210, which is then forwarded to the ONT 230. The pre-provisioning data facilitates communication of downstream data (e.g., content) 202a, 202b, 203a, 203b between the OLT 210 and an ONTs 230 using standard communications protocols known in the art. For example, downstream data 202a, 202b may be broadcast with identification (ID) data to identify intended recipients for transmitting the downstream data 202a, 202b from the OLT 210 through optical splitter/combiner 220 to an upstream port 232 of the ONT 230. Time division multiple access (TDMA) may be used for transmitting the upstream data 203a, 203b from individual ONT 230 through optical splitter/combiner 220 back to the OLT 210. Data communications may include traffic on a Physical Layer Operations, Administration, and Maintenance (PLOAM) channel, an Operations Management and Control Interface (OMCI) channel, or an in-band traffic channel.

In FIG. 2, a downstream port 236 of the ONT 230 communicates with local user agents 250a-c over a shared BUS 245, such as an Ethernet connection. Rather than using a IP-PBX device to manage the directory of all user agents 250a-c and their corresponding SIP addresses, the ONT includes an IP-PBX operating parameter 235 (also referred to herein as a “personality”) that enables it to perform IP-PBX services within the ONT 230.

In the system 200, data communications 202c, 202d may be transmitted from an ONT 230 directly to the local user agents 250a-c in the form of voice communications or pre-provisioning data. The IP-PBX personality 235 within the device ONT 230 maintains a directory of all user agents 250a-c and their corresponding SIP addresses by registering and assigning extension addresses to the user agents 250a-c. Thus, the ONT 230 is able to connect an internal call (i.e., between user agents 250a-c), or route an external calls without the use of a separate IP-PBX device within the local network.

By providing an IP-PBX personality 235 on the ONT 230, local network operators, such as home owners or small business owners, can receive IP-PBX services without having to acquire or maintain additional hardware. Initial provisioning of the PBX is straightforward. With a network interface, a local network operator can configure the PBX from its own local area network. The operator does not have to access the ONT locally to configure the PBX. Further, as subscribers to ONT Broadband services, a GUI interface may be provided to allow for provisioning of PBX systems for the home or office.

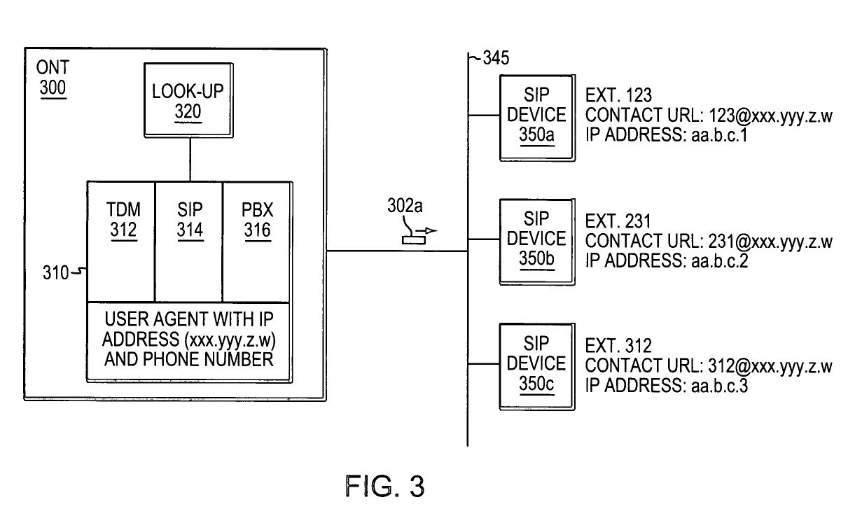

FIG. 3 is a block diagram of an optical networking terminal (ONT) 300 having an integrated IP-PBX of FIG. 2. ONT devices typically use ONT operating parameters 310 (also referred to as “personalities”) to operate in a PON. Examples of existing ONT operating parameters include parameters for Time-Division Multiplexing (TDM) for ATM Adaptation Layer Type 1 (AAL1) 312 and Session Initiation Protocol (SIP) mode 314. In example embodiments of the invention, a new ONT personality of “PBX Personality” 316 provides the IP-PBX services from the ONT 300. The personalities 310 of the ONT 300 operate and identify as a single user agent with a single IP address and phone number. As shown in FIG. 3, a look-up table (or routing table) 320 provides a contact Uniform Resource Identifier (URI) directory of all user agents 350a-c and their corresponding SIP addresses, allowing communications 302c to be directed to specific user agents.

The SIP personality 314 provides an Integrated Analog Telephone Adapter (ATA) Feature, and the ONT works as a “User Agent” with an IP address (e.g. xxx.yyy.z.w) and phone number. The ONT receives an IP Address from the SIP Network and uses the IP Address to register against a SIP Server (or SIP Registrar). Once the ONT registers, the plain old telephone service (POTS) interface get assigned with a phone number.

There are several differences between the PBX personality 316 and the SIP personality 314. With the PBX personality, the ONT itself serves as the SIP Registrar. The IP Address received from the SIP Network is used as the SIP Server to register other “User Agents.” Once the other User Agents register, the ONT routes the phone numbers that have been assigned to the User Agents. User Agents are then considered external devices connected to the Ethernet Port of the ONT. Example User Agents can be SIP Phones, ATA, or Soft Phones on a PC. By having a PBX personality 316 within the ONT, both the SIP personality 314 and the PBX personality 316 may share the same SIP stack, as the ONT 300 will retrieve IP Address from a DHCP Server on the network.

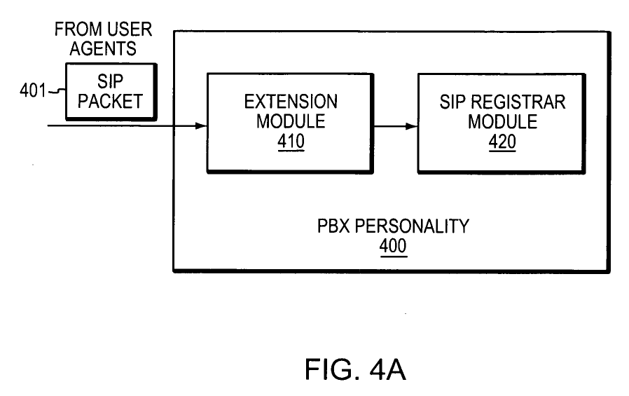

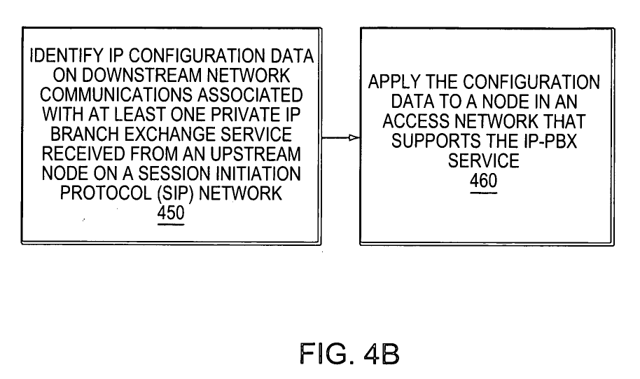

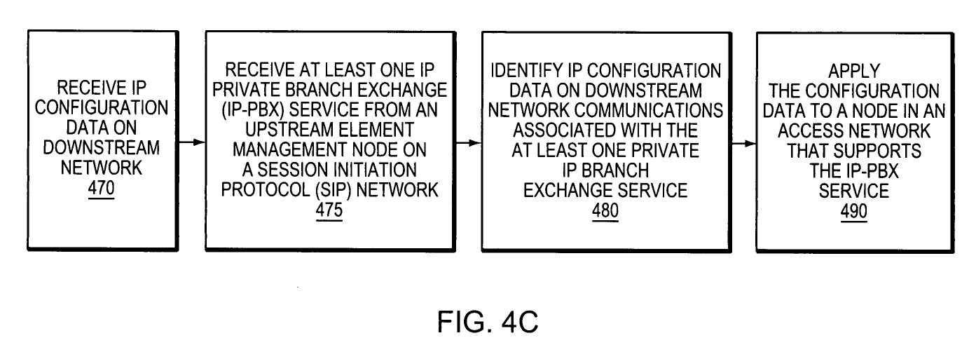

FIG. 4A is a block diagram of a PBX personality 400 according to an example embodiment of the invention. FIG. 4B is a flow diagram illustrating a procedure of managing an Internet Protocol (IP) private branch exchange (IP-PBX) in a node. In FIG. 4A, the PBX personality 400 includes an extension module 410 that is used to register multiple SIP user agents and to allow user agents place calls between extensions. End-to-end connections along with its composite bearer flows are established in accordance with standard signaling protocols (e.g., Session Initiation Protocol (SIP)) conveyed across a control plane (i.e., a packet-based signaling network used to set up, maintain, and terminate data plane connections) between the connection endpoints. Within the control plane, a connection controller typically acts as an intermediate signaling agent in directing the establishment of the data plane resident bearer flows supporting the requested connection. Using SIP signaling, SIP packets 401 arrive from user agents. An ONT uses SIP packets to establish the downstream network IP configuration.

As shown in FIG. 4B, the procedure of managing the IP-PBX includes identifying (450) IP configuration data on the downstream network communications for which a private IP branch exchange service may be provided. The configuration data may be stored in the ONT as a look-up table (320 of FIG. 3) in a “flash” memory device or other memory device so that all configured parameters are saved after the ONT reboots or power cycles.

Continuing with the procedure shown in FIG. 4B, the configuration data is then applied (460) to support PBX services to User Agents. This may occur in a SIP registrar module 420 of FIG. 4A that allows a PBX personality to apply the configuration data. One skilled in the art will recognize that other software modules (not shown in FIG. 4A) may operate on a PBX personality to assist in provisioning particular IP-PBX features or to connect to the PSTN and for PSTN numbers to be routed back to the PBX.

FIG. 4C illustrates a procedure according to an example embodiment of the invention. As mentioned above with respect to FIG. 3, using SIP signaling, SIP packets 401 arrive from user agents. An ONT uses SIP packets to establish the downstream network IP configuration (470). At least one IP-PBX service is provided (475) to the ONT, from for example, an element management system from an upstream communications. In some example embodiments, a local network operator can determine and configure their own IP-PBX service requirements. An ONT identifies (480) IP configuration data on the downstream network communications for which a private IP branch exchange service may be provided, and subsequently applies the configuration data (490) to support PBX services to User Agents.

The actual provisioning of the IP-PBX functionality on the ONT can be performed by either a field technician or directly by a customer. The ONT is provided with the modules for the PBX personality. The customer would then need to customize the PBX. In one example application, two cross connects are provisioned. One connection is for the PBX services, and the other connection is for customer's broadband service. Before the PBX is configured, both connections are inaccessible. Pre-provisioning data may be sent to the ONT to initiate the registration procedure. The pre-provisioning may be initiated either from a management node upstream from the ONT or from a local user's management interface.

To access the management interface, a network interface on the Ethernet port of the ONT becomes available. By default, in the example network of FIG. 3, only an IP Address of xxx.yyy.z.w (e.g. 192.168.0.1) may available to the customer. As example, the IP address 192.168.0.1 is a private Internet Protocol version 4 (IPv4) network address and is the default for certain home broadband routers. This address is set by the manufacturer at the factory, but one can change it at any time using the network router's administrative console. Home routers can use it to establish the default gateway. Customers may be able to access the management interface using a network browser or the like pointing to the management address. As discussed above, the ONT may obtain the local IP addresses from the user agents through SIP initiation signaling. By providing a management interface, customers may assign extension numbers for each of the user agents (IP devices 350a-c of FIG. 3) that correspond to the local IP addresses obtained by the ONT on the network. The customer may also use the management interface to set up any particular features of the IP-PBX, such as voicemail, electronic receptionist, etc.

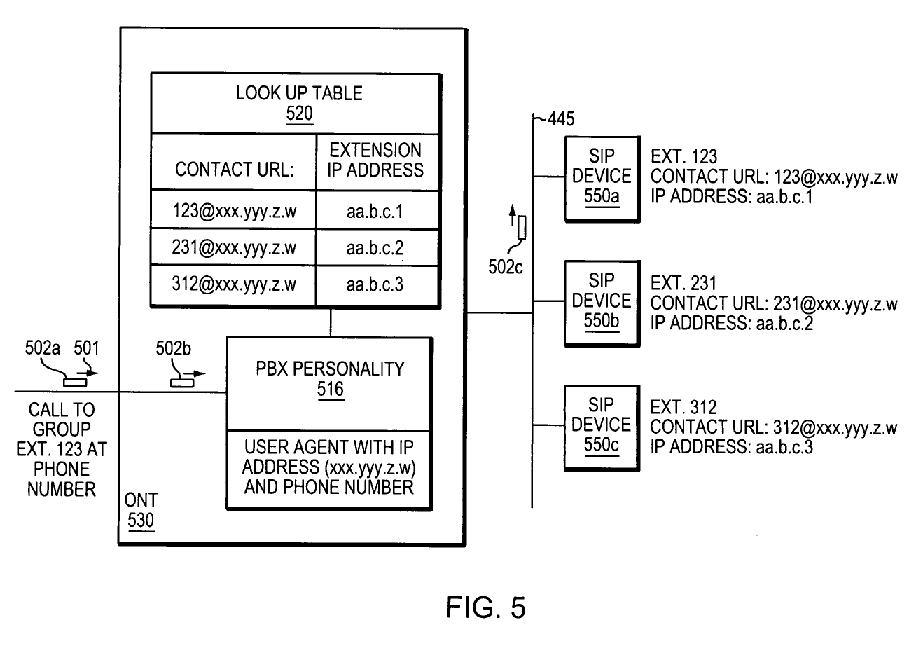

FIG. 5 is a more detailed block diagram of an ONT 430 in PBX personality 416 operation according to an example embodiment of the invention. The ONT operates as a distinct user agent with both an IP Address and a phone number. As a call initiation signal 502a (call-set up) is received at the ONT 530, and an extension number provided for a particular device (e.g., Ext. 123) within the PBX, the call initiation signal 502b is sent to PBX personality 516. At the PBX personality, the contact URI (e.g., 123@xxx.yyy.z.w) is correlated with an extension IP address (e.g., aa.b.c.1) from a look-up table 520 in order to forward the call signal 502c to the appropriate device. Similarly, when a call is received within the PBX from a particular SIP Device extension, the call may be routed through the PBX personality, back to the particular user agent on the SIP network.

While this invention has been particularly shown and described with references to example embodiments thereof, it will be understood by those skilled in the art that various changes in form and details may be made therein without departing from the scope of the invention encompassed by the appended claims.

For example, any of the flow diagrams described herein may be modified or arranged in any manner to support operation in various network configurations. The flow diagrams may include more or fewer blocks, combined or separated blocks, alternative flow arrangements, or the like. The flow diagrams may also be implemented in the form of hardware, firmware, or software. If implemented in software, the software may be written in any suitable code in accordance with the example embodiments herein or other embodiments. The software may be stored in any form of computer readable medium and loaded and executed by a general purpose or application specific processor suitable to perform the example embodiments described herein or other embodiments.

What is claimed is:

1. A method of managing an Internet Protocol (IP) private branch exchange (IP-PBX) services in a node, the method comprising:
identifying IP-PBX configuration data on downstream network communications associated with at least one private IP branch exchange service received from an upstream node on a session initiation protocol (SIP) network; and
applying the configuration data to a node in an access network that supports the IP-PBX service.

2. The method of claim 1 wherein the node is an optical networking terminal (ONT).

3. The method of claim 1 further comprising managing from a remote location upstream of the node, IP-PBX services as a function of the configuration data.

4. The method of claim 1 further comprising accepting pre-provisioning data from a management node upstream of the node.

5. The method of claim 4 further comprising accepting provisioning data from user agents coupled to the node from downstream of the node, the provisioning data corresponding to the pre-provisioning data.

6. The method of claim 5 further comprising providing IP-PBX services for the user agents through the use of the provisioning data.

7. The method of claim 1 further comprising entering IP addresses for IP-PBX user agents local to the node and user agents external from the node in the same stack.

8. An optical network terminal comprising:
a downstream port configured to receive IP configuration data on downstream network communications;
an upstream port configured to receive at least one private IP branch exchange service from an upstream node on a session initiation protocol (SIP) network; and
a processor configured to identify IP configuration data received from the downstream network communications associated with at least one private IP branch exchange service received on the upstream port and to apply the configuration data to a local area network supported by the optical network terminal.

9. The optical network terminal of claim 8 wherein the processor is configured to provide IP-PBX services as a function of the IP configuration data.

10. The optical network terminal of claim 8 wherein the upstream port is configured to receive pre-provisioning data from a management node upstream of the optical network terminal, the pre-provisioning data to be forwarded to user agents coupled to the optical network terminal.

11. The optical network terminal of 10 wherein the processor is further configured to correlate the pre-provisioning data received at the upstream port with provisioning data received at the downstream port from user agents, the provisioning data corresponding to the pre-provisioning data.

12. The optical network terminal of claim 8 wherein the processor is further configured to provide IP-PBX services for the user agents through the use of the provisioning data.

13. The optical network terminal of claim 8 wherein the processor is further configured to process IP addresses for IP-PBX user agents local to the optical network terminal and user agents external from the optical network terminal in the same stack.

14. The optical network terminal of claim 8 further comprising a memory configured to store user agent extensions corresponding to the IP addresses of the user agent IP-PBX user agents.

15. The optical network terminal of claim 14 wherein the memory is a flash memory.

16. A computer readable medium having stored thereon sequences of instructions, the sequences of instructions including instructions, which, when executed by a processor causes the processor to:
(i) identify IP configuration data on downstream network communications with at least one private IP branch exchange service received from an upstream node on a session initiation protocol (SIP) network; and
(ii) apply the configuration data to a node in an access network that supports the IP-PBX service.

17. A system for managing an internet protocol (IP) private branch exchange in a node, the system comprising:
a first module configured to identify IP-PBX configuration data on downstream network communications associated with at least one private IP branch exchange service received from an upstream node on a session initiation protocol (SIP) network; and
a second module configured to apply the configuration data to a node in an access network that supports the IP-PBX service.

18. An network terminal comprising:
means for identifying IP-PBX configuration data on downstream network communications associated with at least one private IP branch exchange service received from an upstream node on a session initiation protocol (SIP) network; and
means for applying the configuration data to a node in an access network that supports the IP-PBX service.
